(19) United States
(12) Patent Application Publication
(10) Pub. No.: US 2011/0068188 A1
(43) Pub. Date: Mar. 24, 2011

(54) Fuel injector for permitting efficient combustion

(76) Inventor: Franz J. Laimboeck, Goleta, CA (US)

(21) Appl. No.: 12/807,360

(22) Filed: Sep. 1, 2010

Related U.S. Application Data
(60) Provisional application No. 61/275,812, filed on Sep. 1, 2009.

(51) Int. Cl. F02D 1/06; B05B 1/26

(52) U.S. Cl. 239/5; 239/601

(57) ABSTRACT

An embodiment of the invention provides an apparatus for fuel injection that permits efficient combustion. In one embodiment, the apparatus includes: a fuel injector including an injector needle; a fuel injection passage having a fuel injection passage inlet connected to the injector needle and a fuel injection passage outlet; and an air passage having an air passage outlet that is connected to the fuel injection passage and that is located between the fuel injection passage inlet and the fuel injection passage outlet, wherein the air passage provides air that mixes with the fuel in the fuel injection passage so that the fuel will have an increased fuel plume angle as the fuel exits from the fuel injection passage outlet.

### CROSS-REFERENCE TO RELATED APPLICATION

This application claims a priority to and claims the benefit of U.S. Provisional Application No. 61/275,812. U.S. Provisional Application No. 61/275,812 is incorporated herein by reference in its entirety.

### BACKGROUND

Fuel injectors are commonly used to supply fuel to the combustion chamber of an engine. The combustion occurs as soon as the injected fuel spray (fuel plume) has mixed with the air within combustible limits. The following are involved in aiding the bursting of the fuel droplets in the fuel plume in order to start the combustion process: air entrainment (which mixes air with fuel droplets), vaporization, homogenization, pressure, and heat. In a diesel engine, combustion already begins before homogenization begins.

The fuel droplet size typically has a Santer Mean Diameter (SDM) of, for example, approximately 10 micron-meters or less. SDM is measured as a 3^{rd} power of volume and 2^{nd} power of surface. The fuel plume has a high kinetic energy, with typical speed within the range of, for example, approximately 500 meters-per-second to approximately 700 meters-per second. The fuel plume will typically have an opening angle of approximately 3 degrees to approximately 4 degrees.

Two current examples of common types of fuel injector tips that are used are the MicroSac Tip and the VCR tip. Referring initially to FIG. 1A, a partial cross-sectional view of a conventional injector 115 with the MicroSac tip 120 is shown. Fuel 122 is delivered toward the tip 120, will exit through the opening A3 in the tip 120, and will travel along the fuel injection passage 124 prior to combustion. Typically, multiple fuel injection passages 124 are connected via openings (e.g., holes A1 through A4) to the tip 120. In a standard engine, the multiple fuel passages 124 form an umbrella-like arrangement.

FIG. 1B is a partial cross-sectional view of a conventional injector 150 with the VCR tip 155. As known to those skilled in the art, the VCR tip has a conical design for the injector needle and reduces soot formation by reducing the drip of fuel droplets from the injector tip. Also, the small conical configuration of a VCR tip is advantageous in reducing the cavitation bubbles that form due to the high pressure flow of the fuel. Multiple fuel injection passages 160 are connected to the VCR tip 155.

In a standard engine, the multiple fuel injection passages 160 form an umbrella-like arrangement. As will be discussed below, embodiments of the invention can be used with a fuel injector that has the MicroSac tip or the VCR tip.

It would be advantageous to improve the process of mixing of fuel and air, in order to achieve more efficient combustion. Therefore, improvements in the current technology would be desirable in order to overcome current constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a partial cross-sectional view of a conventional fuel injector with the MicroSac tip.

FIG. 1B is a partial cross-sectional view of a conventional fuel injector with the VCR tip.

FIG. 2 is a cross-sectional view of a fuel injector, in accordance with an embodiment of the invention.

FIG. 3 is a partial cross-sectional view of an apparatus including a cylindrical air passage that is connected substantially perpendicular to a cylindrical fuel injection passage, in accordance with an embodiment of the invention.

FIG. 4 is a partial cross-sectional view of an apparatus including an air passage and a fuel injection passage that are non-perpendicular, in accordance with an embodiment of the invention.

FIG. 5 is a partial cross-sectional view of an apparatus including a fuel injection passage with a conical inlet and conical outlet and an air passage with a conical inlet, in accordance with another embodiment of the invention.

FIG. 6 is a partial cross-sectional view of an apparatus including a fuel injection passage with a bottleneck inlet and conical outlet, in accordance with another embodiment of the invention.

FIG. 7 is a partial cross-sectional view of an apparatus including a fuel injection passage with a conical inlet and bottleneck outlet, in accordance with another embodiment of the invention.

FIG. 8A is a partial cross-sectional view of an apparatus including a fuel injection passage and air passages that provide a swirl (rotation) movement to fuel in the fuel injection passage, in accordance with another embodiment of the invention.

FIG. 8B is a partial cross-sectional magnified view of the fuel injection passage and air passages of FIG. 8A wherein the air passages are connected tangentially to the fuel injection passage, in accordance with an embodiment of the invention.

FIG. 9 is a partial cross-sectional view of an apparatus including a fuel passage and non-parallel air passages that provide a swirl (rotation) movement to fuel in the fuel injection passage, in accordance with another embodiment of the invention.

FIG. 10A is a partial cross-sectional view of an apparatus including a fuel injection passage and tangentially offset air passages that provide a swirl (rotation) movement to fuel in the fuel passage, in accordance with another embodiment of the invention.

FIG. 10B is a partial front cross-sectional view of the fuel injection passage and air passages of FIG. 10A, in accordance with an embodiment of the invention.

FIG. 11 is a partial cross-sectional view of an apparatus including a fuel injection passage with a conical jet and a conical diffusor and tangentially offset air passages, in accordance with another embodiment of the invention.

FIG. 12 is a partial cross-sectional view of an apparatus including a laval nozzle connected to a conical jet and conical diffusor, in accordance with another embodiment of the invention.

FIG. 13 is a partial cross-sectional view of an apparatus including a plurality of laval nozzles, in accordance with another embodiment of the invention.

FIG. 14A is a diagram of an approximation of a fuel plume that can be generated by an embodiment of the invention, where the fuel injection passages are in the same plane;

FIG. 14B is a partial front view of an apparatus including a plurality of fuel injection passages that are not in the same plane, in accordance with an embodiment of the invention.

FIG. 15 is a partial cross-sectional view of an apparatus including a plurality of twisted (non-parallel) fuel inlets, in accordance with another embodiment of the invention.

FIG. 16 is a partial top view of the plurality of twisted fuel inlets in FIG. 15, in accordance with an embodiment of the invention.

FIG. 17A is a partial cross-sectional view of an apparatus with a combination of various features, in accordance with another embodiment of the invention.

FIG. 17B is a partial top cross-sectional view of the apparatus of FIG. 17A, in accordance with an embodiment of the invention.

FIG. 17C is another partial top cross-sectional view of the apparatus of FIG. 17A, in accordance with an embodiment of the invention.

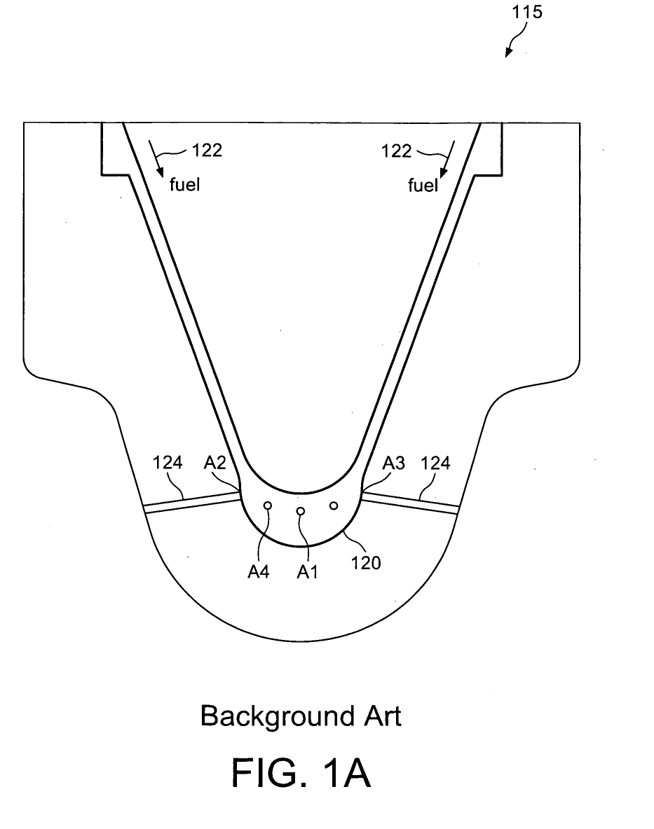

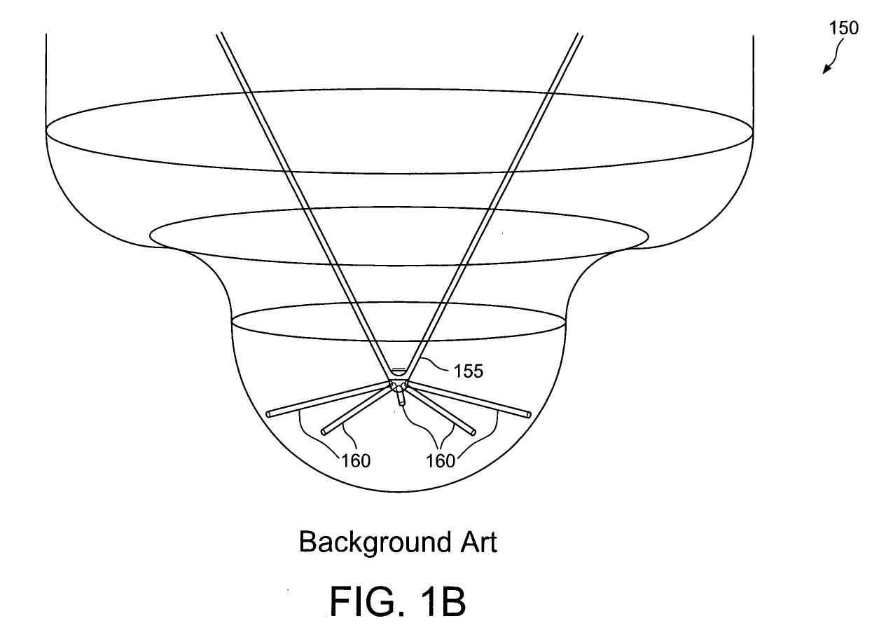

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

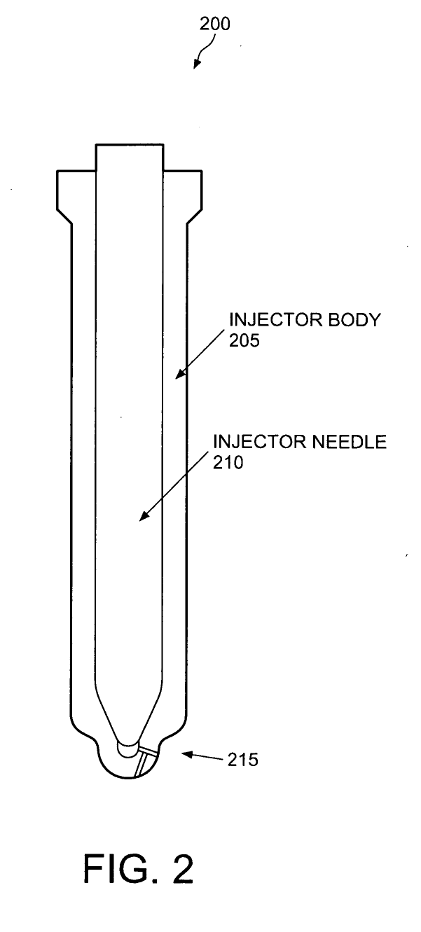

FIG. 2 is a cross-sectional view of a fuel injector (apparatus) 200, in accordance with an embodiment of the invention. In this embodiment, the fuel injector 200 is shown with a MicroSac Tip. However, another embodiment of the invention can also be implemented with other injector tip types such as, for example, a VCR tip or other injector tip types that are currently available or that may be developed as the state of the art improves. The injector 200 includes an injector body 205 and injector needle 210. The details of the injector tip section 215 will be discussed below.

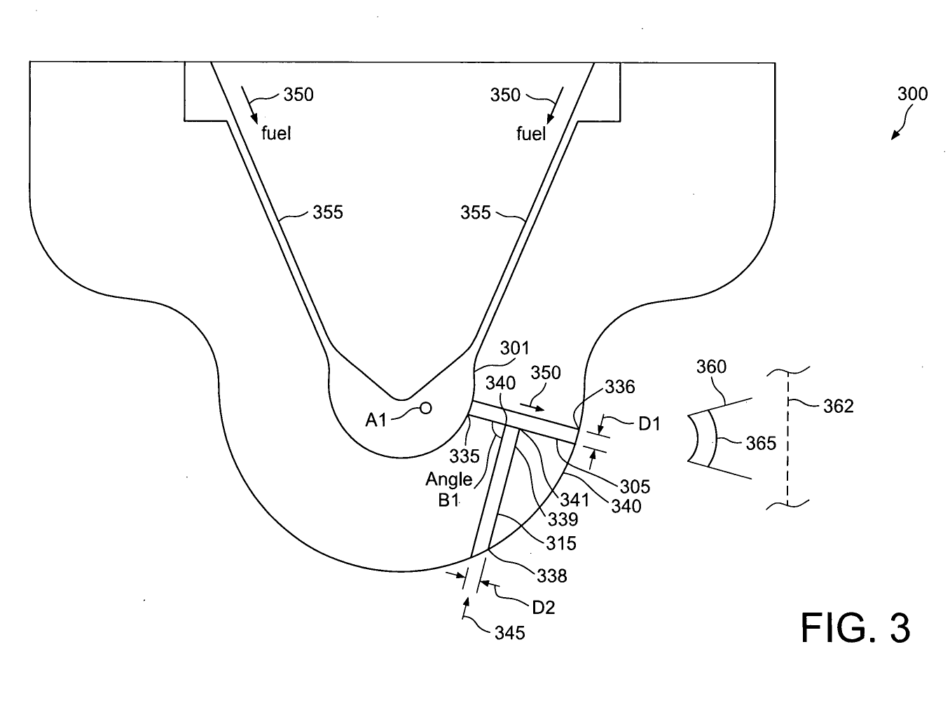

FIG. 3 is a partial cross-sectional view of an apparatus 300 including a fuel injection passage 305 and an air passage 315 that is connected substantially perpendicular to the fuel injection passage 305, in accordance with an embodiment of the invention. In an embodiment of the invention, the apparatus 300 is a fuel injector 300. The fuel injection passage 305 is connected to an injector tip 301 (injector needle 301) of the fuel injector 300.

In an embodiment of the invention as shown in FIG. 3, the fuel injection passage 305 has a constant diameter D1 (i.e., a constant fuel injection passage diameter D1 or constant fuel injection passage radius). Therefore, the fuel injection passage 305 is, for example, a cylindrical passage when the diameter D1 is a constant value.

In an embodiment of the invention as shown in FIG. 3, the air passage 315 also has a constant diameter D2 (i.e., a constant air passage diameter D2 or constant air passage radius). Therefore, the air passage 315 is, for example, a cylindrical passage when the diameter D2 is a constant value.

As a non-limiting example, the fuel injection passage 305 has a diameter D1 of approximately 0.15 mm while the air passage 315 has a diameter D2 of approximately 0.08 mm. However, D1 and D2 can be at other values. Also, as will be discussed below, each of the diameters D1 and D2 are not required to be constant.

In a preferred embodiment of the invention, the air passage diameter D2 (i.e., second diameter D2) of the air passage 325 is less than the fuel injection passage diameter D1 (i.e., first diameter D1) of the fuel passage 305.

In an embodiment of the invention as shown in FIG. 3, the air passage 315 is connected substantially perpendicular (90 degrees or substantially 90 degrees) to the fuel injection passage 305. Therefore, the angle B1 between the passages 305 and 315 is approximately 90 degrees (or substantially 90 degrees) in value. In other embodiments to be discussed below, the angle B1 is an acute angle.

In an embodiment of the invention as shown in FIG. 3, the fuel injection passage inlet (A3) 335 and fuel injection passage outlet 336 (of the injection passage 305) are each a round hole or a substantially round-shaped opening. The diameters of the inlet 335 and outlet 336 are also at the constant D1 diameter value which is also the diameter of the fuel injector passage 305. Variations in the shape of the inlet 335 and outlet 336 will be discussed below in other embodiments of the invention.

In an embodiment of the invention as shown in FIG. 3, the air passage inlet 338 of the air passage 315 is a round hole or a substantially round-shaped opening. The diameter of the inlet 338 is at the constant D2 diameter value which is also the diameter of the air passage 315. Variations in the shape of the inlet 338 will be discussed below in other embodiments of the invention.

The features of various embodiments of the invention can be used with a fuel injector that has a MicroSac tip, a VCR tip, or other injector tip types that are currently available or that may be developed as the state of the art improves.

The air passage outlet 339 of air passage 315 is connected at a location 340 which is between the fuel injection passage inlet 335 and fuel injection passage outlet 336 of the fuel injection passage 305. The location 340 in the fuel injection passage 305 will contain an opening 341 for receiving the air flow 345 that is flowing along the air passage 315. The opening 341 will also permit the air flow 345 to mix with fuel 350 that is flowing along the fuel injection passage 305. The fuel 350 will first flow along the inner cylinder wall 355 and then will flow along the fuel injection passage 305. The fuel 350 will then exit from the outlet 336 as a fuel plume 360. The fuel plume 360 will contain fuel droplets and air 345 that is entrained with the fuel droplets.

The injection pressure for the fuel 350 is, for example, approximately 2,000 bar or other suitable values. This large amount of pressure can lead to the compressibility of the fuel liquid at up to, for example, approximately 5% to approximately 6%. Additionally, the injector tip 301 can have, for example, approximately 280 degrees to approximately 300 degrees of heat.

The fuel 350 can be, for example, diesel, gasoline, ethanol, ammonia, or other types of fuel such as other hydrocarbons, alcohols, or other diesel. It is also noted that embodiments of the invention can be used for direct injection or other types of fuel injections such as, for example, manifold injection.

The location 340 is between the fuel injection passage inlet 335 and fuel injection passage outlet 336. In one preferred embodiment, the location 340 is at an approximate midpoint in the passage 305 between the ends 335 and 336.

The fuel plume 360 exits the fuel passage 305 via outlet 336 into a combustion chamber which is shown symbolically as chamber 362 in FIG. 3 for purpose of clarity in the drawings.

The air flow 345 (which flows along the air passage 315) is generated, for example, from the natural engine suction or pressurized flow from a turbocharger or supercharger, from air in the chamber 362 or from other suitable air generation sources. Standard air flow driving devices (not shown in FIG. 3) may be used to control the air flow 345 through the air passage 315.

The passages 305 and 315 can be metal pipes, or metal alloys, iron, or other suitable materials that form the cylinders of passages 305/315. The passages 305/315 can be connected to each other by use of standard methods such as welding, molding, or other suitable known techniques for connecting metal materials, metal alloys, iron, or other suitable passages to each other.

Note that additional fuel passages 305 (for permitting fuel flow) can be connected to the injector tip 301. For example, an additional fuel passage (not shown in FIG. 3) can be connected, via injection hole Al, to the tip 301. This additional fuel passage (which is connected via hole A1) will also be connected to an additional air passage for permitting air flow. As one example, up to ten (10) fuel passages (with each fuel passage connected to an associated air passage) can be connected to the tip 301, and these fuel passages can, for example, form an umbrella-shaped configuration around the tip 301.

The fuel plume 360 will be an air-fuel mixture that is exiting from the fuel injection passage outlet 336 and will reach a certain depth penetration (i.e., length) into the combustion chamber 362, and will also roll up adjacent to the injector tip 301 due to the back pressure in the surrounding air in the combustion chamber 362. The core of the air-fuel mixture (in the plume 360) is liquid formed by the fuel droplets that travel together. The fuel droplets in the air-fuel mixture will burst up during the conversion of the kinetic energy of the flow of the air-fuel mixture and vaporize partly, which delays the combustion due to the removal of the vaporization heat. For combustion to occur, the correct amount of fuel and correct amount of air are needed to be present within the combustion limits.

By connecting the air passage 315 to the fuel injection passage 305 at location 340, an enhanced mixing of fuel 350 and air 345 in the fuel injection passage 305 is achieved, prior to fuel combustion in the combustion chamber 362 and to take advantage of the Venturi principle during the mixing of fuel and air prior to combustion. The air flow 345 will enter via the air passage inlet 338, will flow along the air passage 315, and will then mix with the fuel 350 in the fuel injection passage 305. The air-fuel mixture (which is formed due to mixing of air flow 345 with the fuel 350 and due to the air entrainment in the fuel 350) will exit from the fuel injection passage outlet 336 as a fuel plume 360 which is formed by an air-fuel mixture.

Since there is more air content in the air-fuel mixture of the plume 360 that exits the outlet 336 (due to the increased air entrainment provided by the air passage 315 to the fuel 350 in the fuel passage 305), the plume angle 365 of the fuel plume 360 will be wider, as compared to the plume angle that is achieved by previous approaches. The larger surface area of the plume 360 (due to the wider plume angle 365) results in the surrounding air in chamber 362 in breaking down the fuel droplets (in the plume 360) at a faster rate. The wider plume angle 365 can also result in a shorter length of the plume 360. Since the plume 360 will have a wider plume angle 365, the fuel droplets (in the plume 360) will be smaller in size and will disintegrate more quickly, resulting in an improved and efficient fuel combustion process.

In contrast, in current technology, there is a longer ignition delay due to the rich fuel mixture that is received by the combustion chamber and due to the vaporization heat that is extracted during vaporization. Soot and particulates are formed due to the rich fuel mixture and insufficient air, because the meeting of air and fuel does not happen in a desirable way or time.

On the other hand, an embodiment of the invention provides more air 345 to the fuel stream 350 at an earlier time as compared to conventional technology, and consequently, provides a wider plume angle 365, as discussed above. As a result, the fuel droplets will disintegrate at a faster rate in the combustion chamber 362 and the soot formation problems of previous approaches are advantageously avoided or reduced.

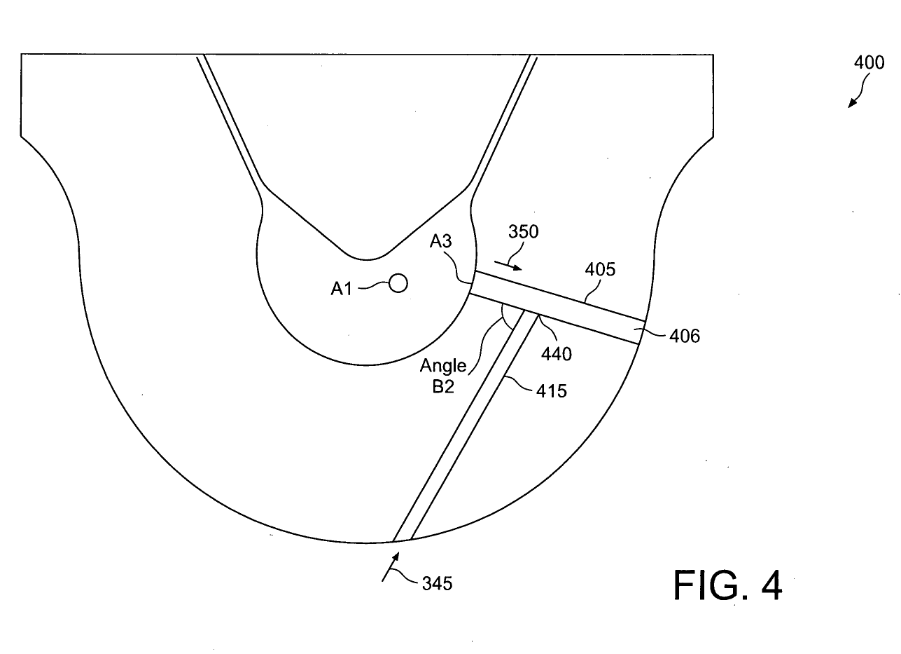

FIG. 4 is a partial cross-sectional view of an apparatus 400 including an air passage 415 that is connected in an acute angle B2 relative to the fuel injection passage 405, in accordance with an embodiment of the invention. In this embodiment, the angle B2 formed between passages 405 and 415 is substantially at an acute angle value (i.e., less than 90 degrees). Therefore, passages 405 and 415 are non-perpendicular to each other. Therefore, the direction of the air flow 345 is pointed substantially toward the direction (from inlet A3 to outlet 406) of the flow of the fuel 350 in the passage 405. As one non-limiting example, the angle B2 is at value of approximately 75 degrees or other acute angle values.

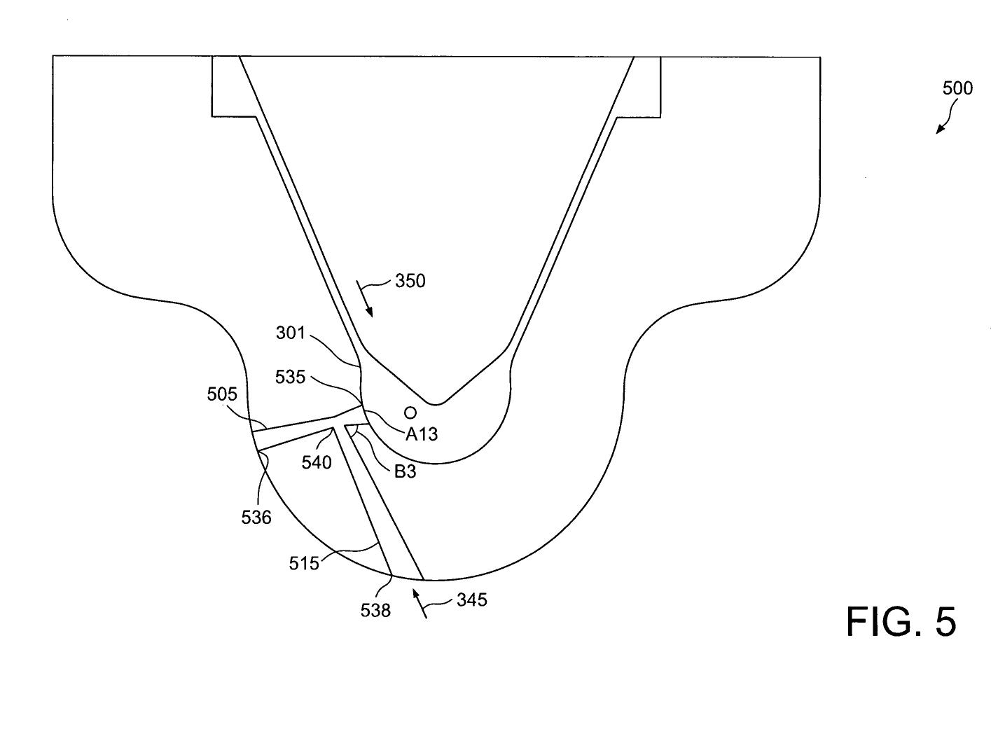

FIG. 5 is a partial cross-sectional view of an apparatus 500 including a fuel injection passage 505 with a conical inlet 535 and conical outlet 536 and an air passage 515 with a conical inlet 538, in accordance with another embodiment of the invention. Because of the conical shapes of the fuel injection passage 505 and air passage 515, the diameters of the passages 505 and 515 are not constant. The conical shapes, bottleneck shapes, and/or bell-mouth (funnel) shapes for the inlets and outlets of the various fuel injection passages and air passages, as discussed herein, provide a decreased flow resistance in the passages.

The passages 505 and 515 are non-perpendicular to each other, and, therefore, the angle B3 between the passages 505 and 515 is acute. For example, the angle B3 is 80 degrees or another acute angle value. In another embodiment of the invention, the angle B4 is 90 degrees, and, therefore, the passages 505 and 515 are perpendicular to each other.

The fuel injection passage 505 is connected via injection hole A13 to the injection tip 301, and the air passage 515 that is connected to the fuel injection passage 505 at location 540. Since the inlet 535 and the outlet 536 are conical, a Venturi is formed at the location 540.

The conical inlet 535 reduces the flow restriction on the fuel that is entering into the fuel injection passage 505. A conical inlet 535 (or a substantially rounded inlet) reduces cavitation in the fuel injection passage 505. Cavitation is caused by burbling on the passage inner wall near the intake opening that receives the fuel flow because the fuel flow would not immediately contact that passage inner wall. When the flow pressure at that passage inner wall falls below the vapor pressure, cavitation occurs and this can lead to the tearing of parts of the passage material. Therefore, a conical inlet 535 (or a substantially rounded inlet) advantageously reduces the occurrences of cavitation.

Since the inlet 535 and outlet 536 of the fuel injection passage 505 are conical, the passage 505 will not have a constant diameter D1. Instead, the fuel injection passage 505 will have a diameter D1 that varies in value, depending on the particular location along the fuel injection passage 505. For example, at location 540 where the air passage 515 connects to the fuel injection passage 505, the diameter D_{M} of the fuel injection passage 505 is at a minimum value (e.g., approximately 0.08 mm). The diameter Dᵢₙₗₑₜ (e.g., approximately 0.12 mm) at inlet 535 of fuel injection passage 505 and the diameter Dₒᵤₜₗₑₜ (e.g., approximately 0.12 mm) at outlet 536 of fuel injection passage 505 are each greater than the diameter D_{M} at location 540, in order to have the Venturi in the fuel injection passage 505. In other words, Dᵢₙₗₑₜ>D_{M} and Dₒᵤₜₗₑₜ>D_{M}.

Therefore, the fuel injection passage 505 will not be cylindrical in shape, but will instead be a conical shape from the inlet 535 and from the outlet 536, with each of the inlet 535 and outlet 536 having a larger diameter than the diameter D_{M} at location 540. Since Dᵢₙₗₑₜ>D_{M} and Dₒᵤₜₗₑₜ>D_{M}, a Venturi is present in the fuel passage 505. As a result, a depression occurs in the fuel flow 350 in the fuel injection passage 505 and air can be efficiently entrained in the fuel flow in fuel injection passage 505.

As known to those skilled in the art, the Venturi effect is described by Bernoulli's Equation:

P₁+(1/2)(d₁)(v₁)²=P₂+(1/2)(d₂)(v₂)² (1)

where,

P₁=pressure at the inlet of the Venturi;

P₂=pressure at the throat of the Venturi;

d₁=air density at the inlet of the Venturi;

d₂=air density at the throat of the Venturi;

v₁=air velocity at the inlet of the Venturi; and

v₂=air velocity at the throat of the Venturi.

Based on the law of conservation of impulse (Newton/second), mass can neither be created nor destroyed in a closed system, and as such, the volumetric flow rate at a first area A must equal the volumetric flow rate at a second area A″. When area A″ is smaller than area A, the flow traveling through A″ must travel faster in order to maintain the same volumetric flow rate. The increased velocity of the flow results in a decrease in pressure according to the Bernoulli equation.

Therefore, there is less pressure at location 540 where the air flow 345 meets that fuel 350. Therefore, air entrainment in the flow of fuel 350 is efficiently achieved at location 540 because of the lesser pressure at this location.

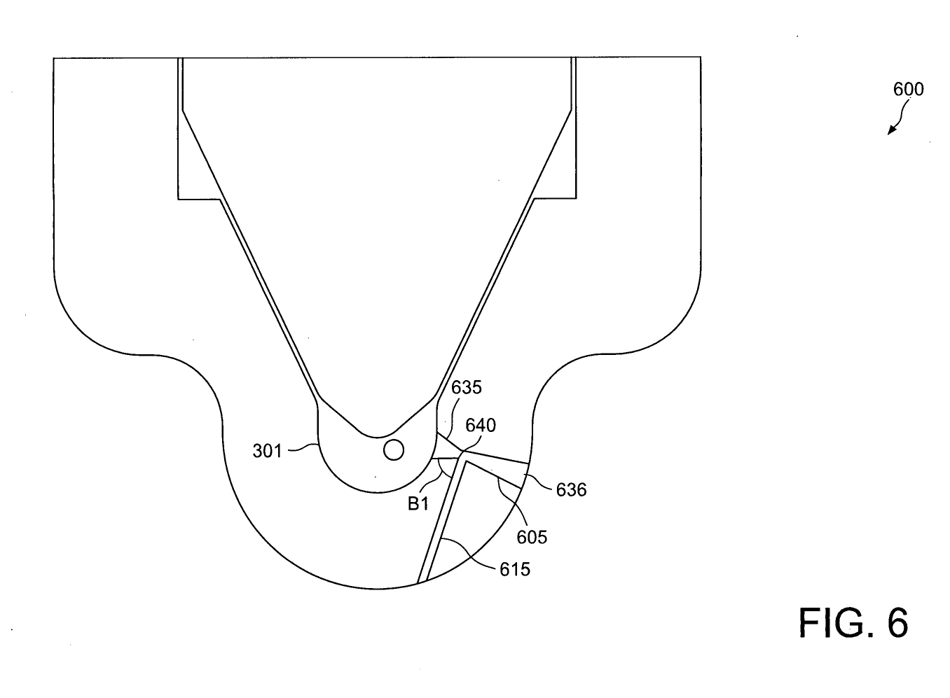

FIG. 6 is a partial cross-sectional view of an apparatus 600 including a fuel injection passage 605 with a substantially bottleneck inlet 635 and substantially conical outlet 636, in accordance with another embodiment of the invention. The bottleneck inlet 635 does not have the sharp edge at the passage opening that receives the fuel flow. Therefore, the bottleneck inlet 635 reduces the flow restriction on the fuel that is entering into the fuel injection passage 605, and therefore, reduces cavitation on the passage 605.

An air passage 615 is connected to the fuel passage 605 at location 640. The air passage 615 can be perpendicular to the fuel passage 605 or can be at an acute angle B1 (e.g., approximately 80 degrees) with respect to fuel passage 605.

The fuel passage 605 will not have a constant diameter D1. Instead, the fuel passage 605 will have a diameter D1 that varies in value, depending on the particular location along the fuel passage 605. For example, at location 640 where the air passage 615 connects to the air passage 605, the diameter D_{M} of the fuel passage 605 is at a minimum value (e.g., 0.08 mm). The diameter Dᵢₙₗₑₜ at inlet 635 of fuel passage 605 and the diameter Dₒᵤₜₗₑₜ at outlet 636 of fuel passage 605 are each greater than the diameter D_{M} at location 630. In other words, Dᵢₙₗₑₜ>D_{M} and Dₒᵤₜₗₑₜ>D_{M}.

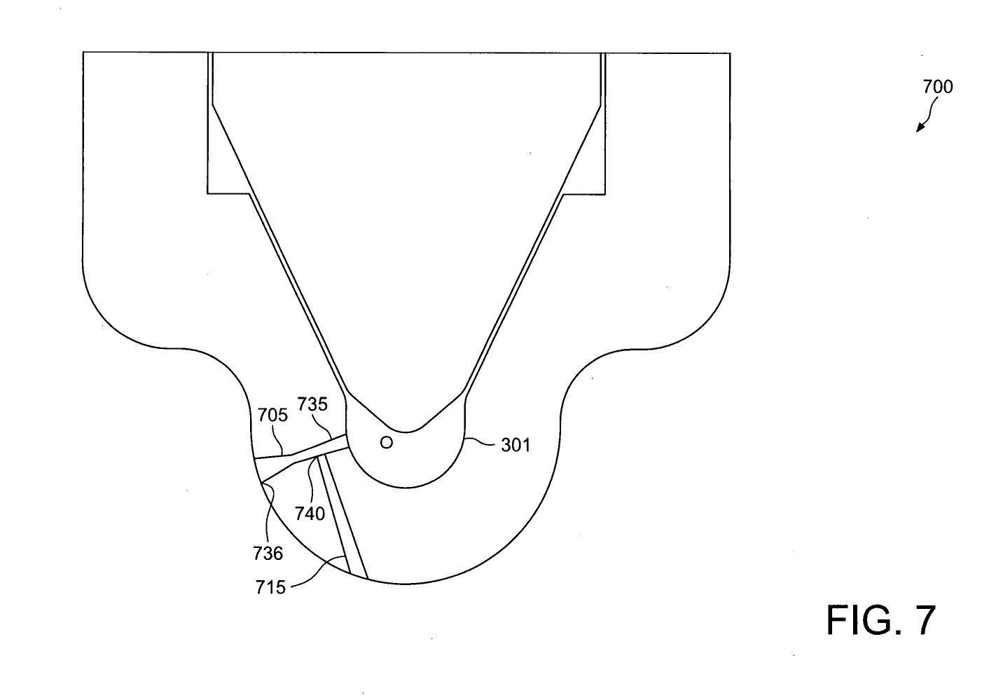

In an embodiment of the invention, the inlet 635 will have a substantially bottleneck shape or other geometric shape. The outlet 636 can also have a substantially bottleneck shape (as shown in FIG. 7) or a substantially conical shape as shown in FIG. 6. Note that embodiments of the invention are not limited to having the geometric shapes of a cone or a bottleneck at inlet 635 or outlet 636. Other suitable geometric shapes may be used at inlet 635 or/and outlet 636 in order to reduce the flow restriction on fuel that flows along the passage 605. Standard manufacturing or machining methods may be used to form the geometric shapes of the fuel passage 605.

Note also that the conical air passage inlet 538 of FIG. 5 may be incorporated in the apparatus 600 of FIG. 6 and in other embodiments of the invention as discussed herein.

FIG. 7 is a partial cross-sectional view of an apparatus 700 including a fuel injection passage 705 with a conical inlet 735 and bottleneck outlet 736, in accordance with another embodiment of the invention. The bottleneck outlet 736 reduces the flow restriction on the fuel that is exiting from the fuel injection passage 705. The fuel injection passage 705 is connected to the injector tip 301, and an air passage 715 is connected to the fuel injection passage 705 at location 740.

The inlet 735 can also have a bottleneck shape (as shown in FIG. 6) or a conical shape as shown in FIG. 7. As in the embodiment of FIG. 6, other suitable geometric shapes may be used at inlet 735 or/and outlet 736 for reducing the flow restriction on fuel that flows along the passage 705.

Note also that the conical air passage inlet 538 of FIG. 5 may be incorporated in the apparatus 700 of FIG. 7 and in other embodiments of the invention as discussed herein.

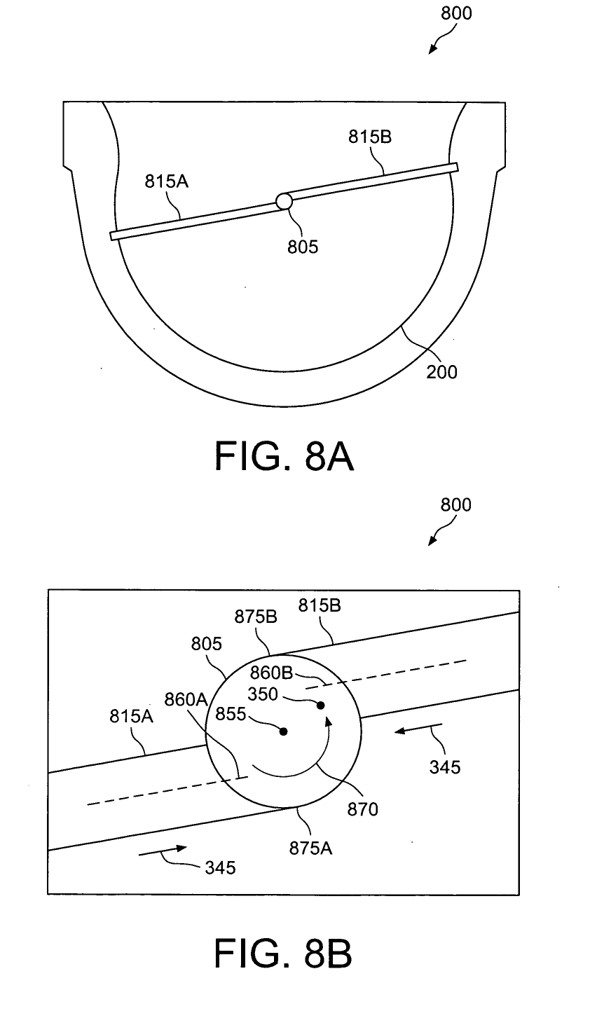

FIG. 8A illustrates a partial cross-sectional view of a fuel injection passage 805 with a centerline 855 that does not intersect with the centerline 860A (of air passage 815A) and centerline 860B (of air passage 815B). Referring first to FIG. 8A, a partial cross-sectional view of an apparatus 800 includes the fuel injection passage 805 and air passages 815A and 815B that provide air flows 345 that will cause a swirl (rotation) movement to fuel 350 in the fuel injection passage 805, in accordance with an embodiment of the invention. The fuel injection passage 805 is connected to injection hole A77 at the injector tip 301.

FIG. 8B is a partial cross-sectional magnified view of the fuel injection passage 805 and air passages 815A and 815B of FIG. 8A, in accordance with an embodiment of the invention. The air passage 815A is substantially tangential to the fuel passage 805 at the tangential junction 875A, while the air passage 815B is substantially tangential to the fuel passage 805 at the tangential junction 875B. Therefore, a tangential junction in the fuel injection passage 805 is the outer wall or outer surface (of the fuel injection passage 805) that is in contact with an air passage.

The centerlines 860A and 860B (of air passages 815A and 815B, respectively) are substantially parallel or can have a slight angle difference. For example, the centerline 860A and 860B can have zero degrees of angle difference (i.e., are parallel) or can have an acute angle difference (e.g., approximately 10 degrees or less).

Since two air passages 815A and 815B are provided, more air 345 are provided for air entrainment in the fuel 350. The air passages 815A and 815B also provide the swirl 870 that provides a twisting movements to the fuel 225. The swirl 870 is an air flow direction that will aid in bursting the fuel droplets in the fuel plume that exits the fuel passage 805 because the swirl 870 (in a counter-clockwise direction in the example of FIG. 8B) introduces centrifugal force to the droplets in the fuel 350. This centrifugal force will cause the fuel plume angle 365 (FIG. 3) to become wider. As a result, the fuel droplets in the fuel plume 360 (as received by the combustion chamber) will burst more efficiently during combustion.

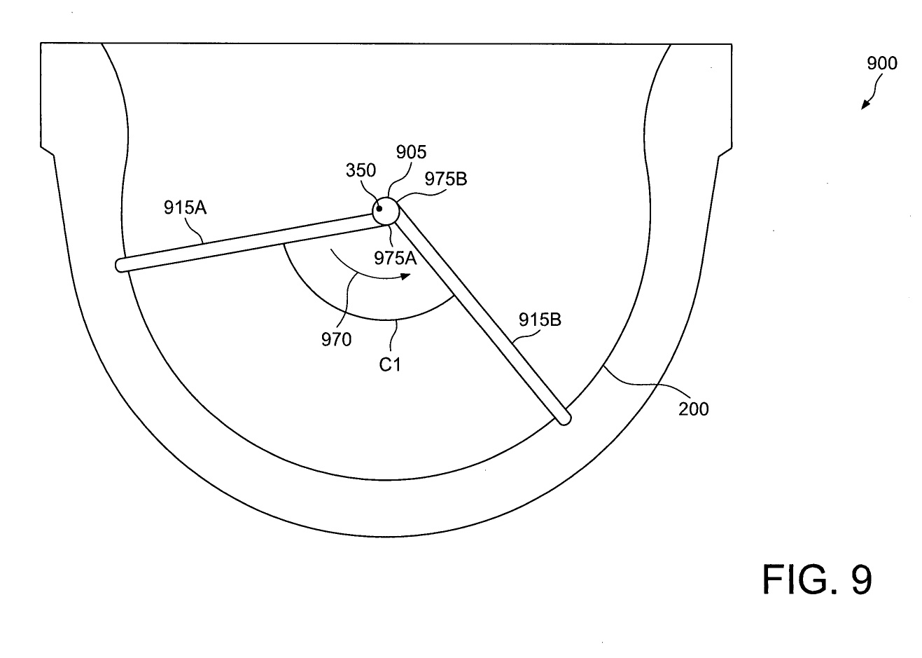

FIG. 9 is a partial cross-sectional view of an apparatus 900 that includes a fuel injection passage 905 and non-parallel air passages 915A and 915B that provide a swirl (rotation) movement 970 to fuel 350 in the fuel injection passage 905, in accordance with an embodiment of the invention. The air passage 915A is substantially tangential to the fuel injection passage 905 at the tangential junction 975A, while the air passage 915B is substantially tangential to the fuel injection passage 905 at the tangential junction 975B. The air passages 915A and 915B are separated by angle C1, where C1 is 90 degrees or greater and less than 180 degrees. Therefore, the air passages 915A and 915B are in an offset configuration and are not parallel.

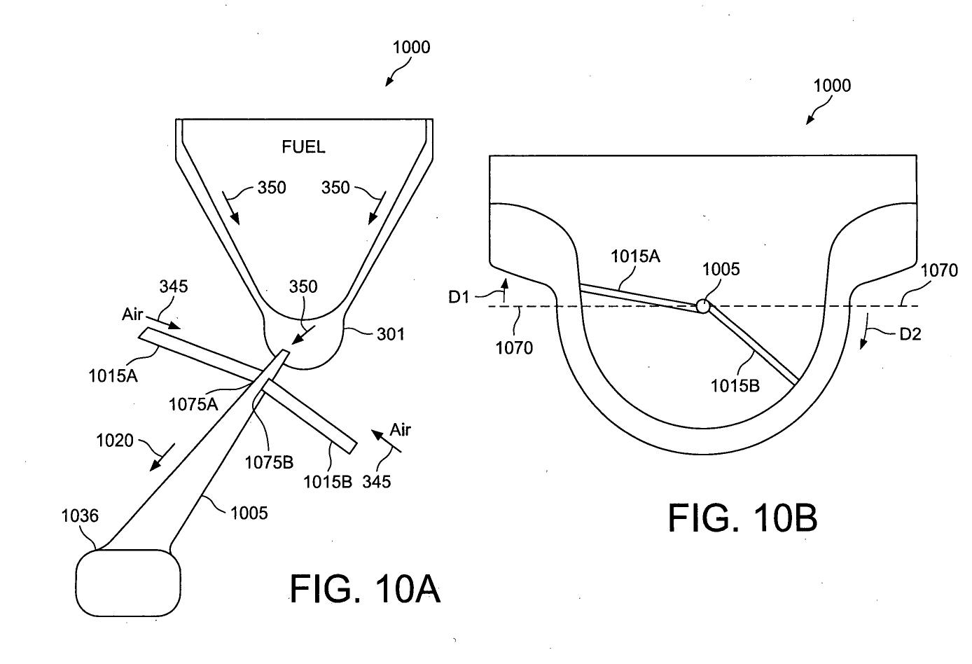

FIG. 10 includes FIGS. 10A and 10B. FIG. 10A is a partial cross-sectional view of an apparatus 1000 including a fuel passage 1005 and tangentially offset air passages 1015A and 1015B that provide a swirl (rotation) movement to fuel 350 in the fuel passage 1005, in accordance with another embodiment of the invention. FIG. 10B is a partial front cross-sectional view of the fuel passage 1005 and air passages 1015A and 1015B of FIG. 10A, in accordance with an embodiment of the invention. The fuel passage 1005 is at a radial downward direction 1020. In another embodiment, the fuel passage outlet 1036 has a geometric shape as an option, such as, for example, conical shape, bell-mouth shape (funnel shape), bottleneck shape, or other suitable geometric shapes that will reduce flow resistance to fuel 350 that flows along the fuel injection passage 1005.

The air passages 1015A/1015B are tangentially offset in configuration. For example, as best shown in FIG. 10B, the air passage 1015A is angled at angle value D1 with respect to horizontal reference line 1070. The angle D1 can be from zero degrees to 90 degrees in value and is typically, for example, an acute angle value. The air passage 1015B is angled at angle value D2 with respect to horizontal reference line 1070. The angle D2 can be from zero degrees to 90 degrees in value and is typically, for example, an acute angle value.

As another option in an embodiment of the invention, the tangential offset to the air passages 1015A and 1015B is based on distance between the respective tangential junctions of the air passages 1015A and 1015B. For example, in FIG. 10A, the air passage 1015A is tangentially connected to the fuel injection passage 1005 at the tangential junction 1075A, and the air passage 1015B is tangentially connected to the fuel injection passage 1005 at tangential junction 1075B. The location 1075A and 1075B are separated by an offset distance Y along the fuel injection passage 1005 (where Y=location 1075A−location 1075B). As a result, the air passage 1015A is offset by the tangential offset distance Y from the air passage 1015B, along the length of the fuel injection passage 1005. This tangential offset distance Y permits the air passages 1015A and 1015B to provide air flow 345 with turbulence that introduces centrifugal force to the fuel droplets in the fuel passage 1005.

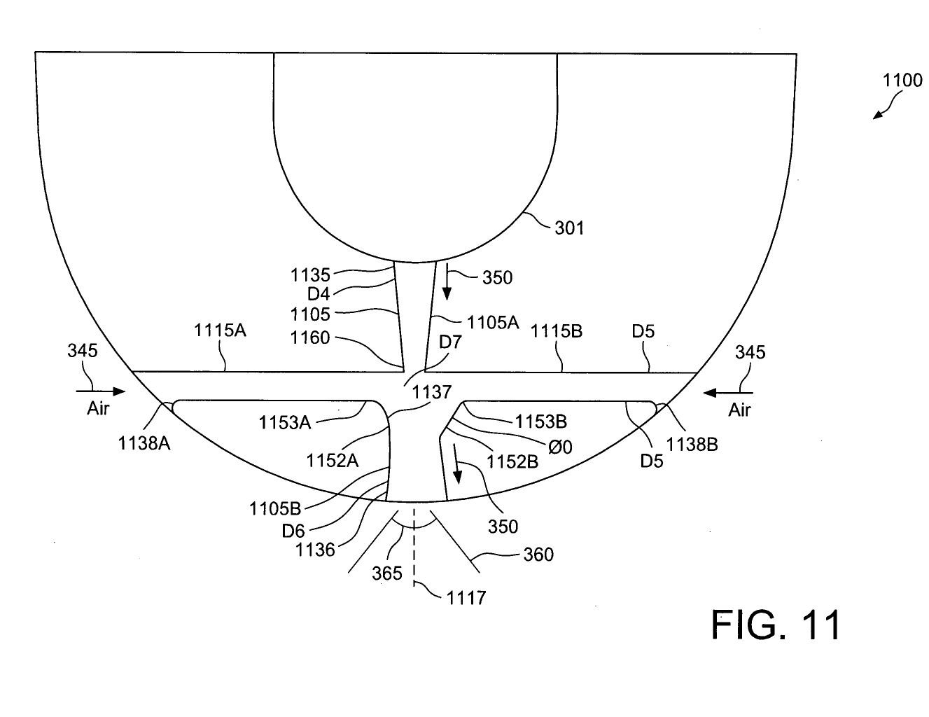

FIG. 11 is a partial cross-sectional view of an apparatus 1100 including a fuel injection passage 1105 with a conical jet 1105A and a conical diffuser 1105B and tangentially offset air passages 1115A and 1115B, in accordance with another embodiment of the invention. The fuel injection passage 1105 has a central axis that has the same direction as the injector axis 1117 of the injector needle 210 (FIG. 2), or is near in the same direction as the axis 1117 of the injector needle 210 with little deviation from the axis 1117. Therefore, the fuel injection passage 1105 is not arranged in the umbrella configuration that has been described above. The spray of the fuel 350 will be in the orientation of the injector axis 1117 or will substantially be in the orientation of the injector axis 1117.

The tangentially offset air passages 1115A/1115B provide a swirl (rotation) movement to fuel in the fuel passage 1105. The air passages 1115A/1115B are tangentially offset in configuration. For example, this tangential offset is achieved by connecting the air passage 1115A to the front surface of the fuel passage 1105 and connecting the air passage 1115B to the rear surface of the fuel passage 1105.

To permit improved air flow 345 into the air passages 1115A and 1115B, each of the inlet 1138A and inlet 1138B has a geometric shape, such as, for example, conical shape, bell-mouth shape (funnel shape), bottleneck shape, or another suitable geometric shape that reduces the flow restriction on the air 345. In the example of FIG. 11, the air passage inlets 1138A and 1138B are each rounded air passage inlets.

Additionally, the outlet 1152A (of air passage 1115A) and the outlet 1152B (of air passage 1115B) can be rounded (or expanded) in shape, as best illustrated in FIG. 11, so that the flow restriction on the air 345 is reduced. However, in other embodiments of the apparatus 1100, the rounded (or expanded) shape of the outlets 1152A/1152B is omitted. As a result, in this alternative configuration, the outlets 1152A and 1152B will have the non-rounded shapes 1153A and 1153B, respectively. The air passages 1115A and 1115B each has a minimum diameter D5 of, for example, approximately 0.16 mm.

The conical jet 1105A reduces cavitation. The conical jet 1105A can be a conical passage with a rounded inlet that receives the fuel flow 350 or can be conical inlet. The conical jet 1105A can be at a minimum conical jet diameter D3 of, for example, approximately 0.08 mm, at conical jet outlet 1160 and at a maximum conical jet diameter D4 of, for example, approximately 0.15 mm at the conical jet inlet 1135. The conical jet diameter decreases from the conical jet inlet 1135 to the conical jet outlet 1160. The cone formed by the conical jet 1105A can be at a cone angle of, for example, approximately 8 degrees.

The conical diffusor 1105B has a larger increasing diameter toward the conical diffuser outlet 1136 and allows for more air 345 to be entrained with the fuel 350. The conical diffusor 1105B can be at a maximum conical diffusor diameter D6 of, for example, approximately 0.24 mm, at conical diffusor outlet 1136. The conical diffusor 1105B can be at a minimum conical diffusor diameter D7 at conical diffusor inlet 1136, where D7<D6 and where the conical diffuser diameter increases from the conical diffuser inlet 1137 to the conical diffuser outlet 1136. The cone formed by the conical diffusor 1105B can be at a cone angle of, for example, approximately 25 degrees.

The conical shape of the conical diffuser 1105B permits the laser machining to swivel via outlet 1136 in order to shape the conical diffusor 1105B and conical jet 1105A into the desired configurations. Other types of standard machining (such as, e.g., electrical discharge machining or EDM) may be used to shape the conical jet 1105A and conical diffusor 1105B.

Since the fuel 350 is traveling from the wider diameter D4 at conical jet inlet 1135 to the narrower diameter D3 at conical jet outlet 1160, a high speed movement is applied to the flow of fuel 350 and the swirl, movement of the air 345 from air passages 1115A and 1115B will also entrain air into the fuel flow, leading to a wider plume angle 365 of the plume 360.

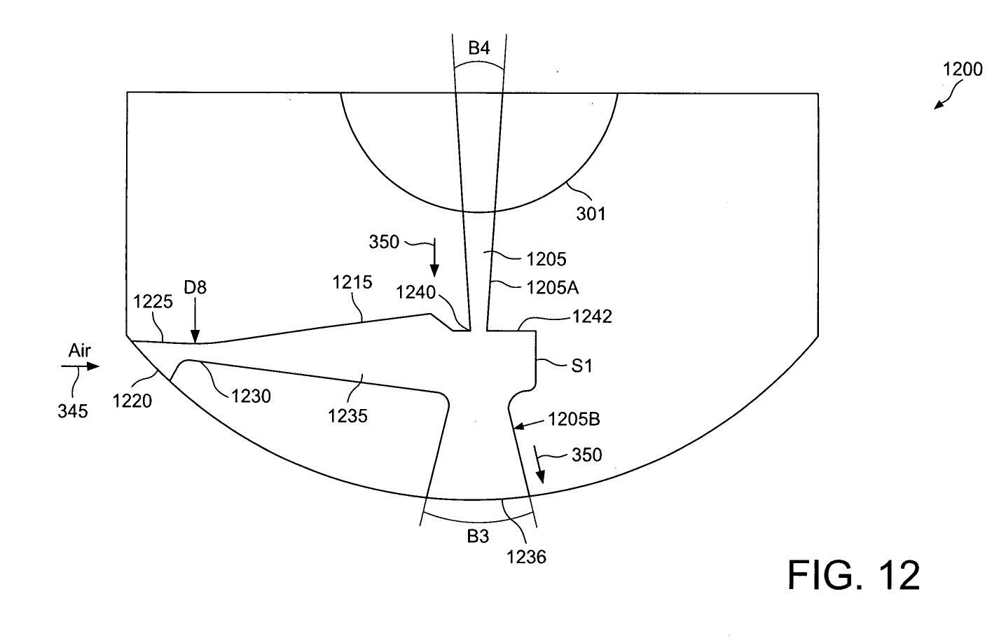

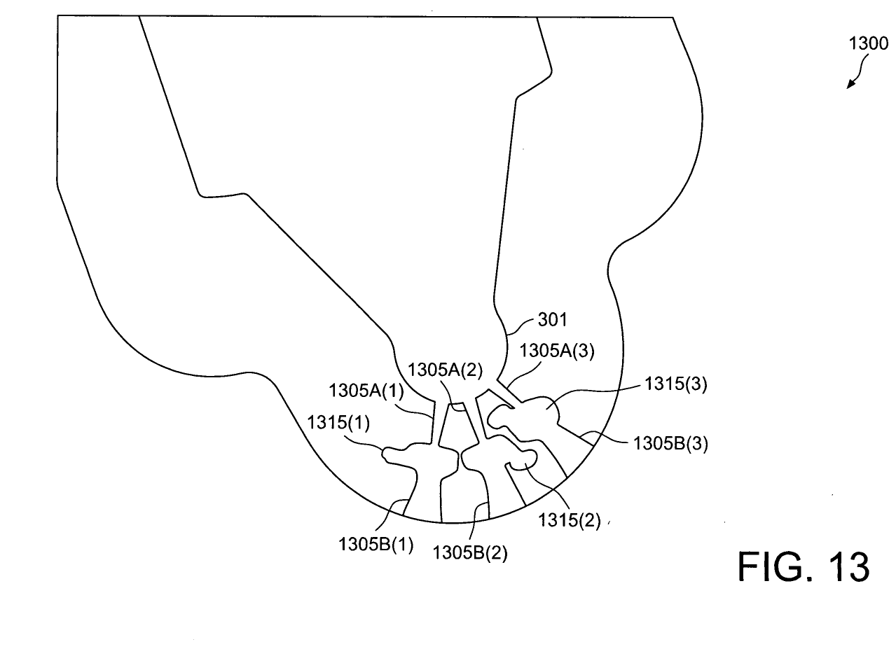

FIG. 12 is a partial cross-sectional view of an apparatus 1200 including a fuel injection passage 1205 and a laval nozzle 1215 which function as an air passage for air 345, in accordance with another embodiment of the invention. As similarly discussed above, the fuel injection passage 1205 is formed by a conical jet 1205A with a cone angle B4 of, for example, approximately 8 degrees, and a conical diffuser 1205B with a cone angle B3 of, for example, approximately 25 degrees. Other details of a conical jet and conical diffuser have also been described above.

The laval nozzle 1215 creates a high speed flow (or increased speed flow) for the air 345 that will be entrained with the fuel 350 that flows along the fuel injection passage 1205. The laval nozzle 1215 includes an inlet opening 1220 of a wide geometric shape opening such as a round opening, rectangular opening, elliptical opening, or other geometric opening. The laval nozzle inlet 1225 can also have conical shape, bell-mouth shape (funnel shape), bottleneck shape, or another suitable geometric shape that reduces the flow restriction on the air 345. In the example of FIG. 12, the inlet 1225 is a bell-mouth shape. The laval nozzle 1215 can be shaped by use of standard machining techniques such as, for example, laser machining or EDM.

A narrow passage 1230 is adjacent to the inlet 1225. The narrow passage 1230 is the minimum laval nozzle diameter D8 value for the laval nozzle 1215. As an example, the diameter D8 is approximately 0.08 mm.

A laval nozzle diffusor 1235 is adjacent to the narrow passage 1230. The diffusor 1235 can have a conical shape or other increasing geometric shape that permits diffusion of the air flow 345 from the narrow passage 1230. The diffused air flow 345 flows from the diffusor 1230 to a volume 1242. The volume 1240 could have a suitable geometric shape such as, for example, a cylinder shape. The volume 1242 will have a widest section S1. As an example, the widest section S1 is approximately 0.6 mm.

Within the volume 1242, the air flow 345 mixes with and is entrained into the fuel 350 that flows from the conical jet 1205A. The air/fuel mixture then flows through the conical diffuser 1205B and exits through the conical diffusor outlet 1236. The outlet 1236 will have a diameter of, for example, approximately 0.52 mm.

The conical jet 1205A will have the smallest diameter value at location 1240 where the conical jet 1205A connects to the volume 1242. The use of the laval nozzle 1215, volume 1242, conical jet 1205A, and conical diffusor 1205B allow the improved entrainment of air 345 into the fuel 350, resulting in a broad plume angle 365 for the plume 360 that exits the outlet 1236 or non-homogenous patterns of decreased fuel droplet sizes in the fuel plume 360.

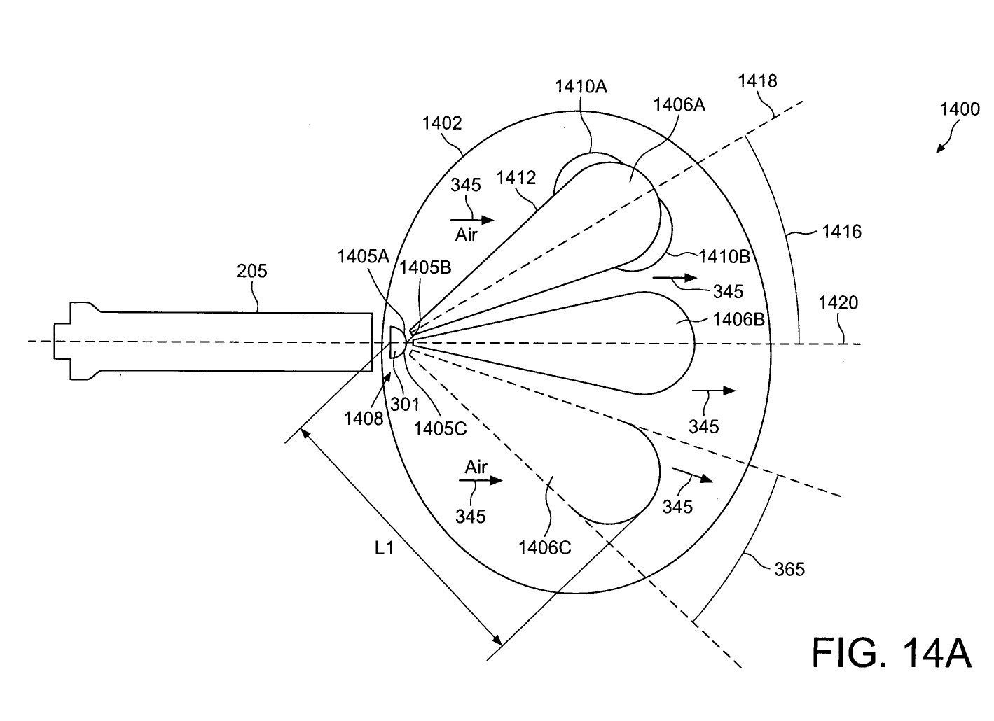

FIG. 13 is a partial cross-sectional view of an apparatus 1300 including a plurality of laval nozzles, in accordance with another embodiment of the invention. Each laval nozzle is connected to a conical jet and conical diffusor. For purposes of clarity, only 3 laval nozzles (1315(1), 1315(2), and 1315(3)) are shown as examples in FIG. 13.

The laval nozzle 1315(1) is connected to the conical jet 1305A(1) and conical diffusor 1305B(1). The laval nozzle 1315(2) is connected to the conical jet 1305A(2) and conical diffusor 1305B(2). The laval nozzle 1315(3) is connected to the conical jet 1305A(3) and conical diffusor 1305B(3). The details of a laval nozzle has been previously described above.

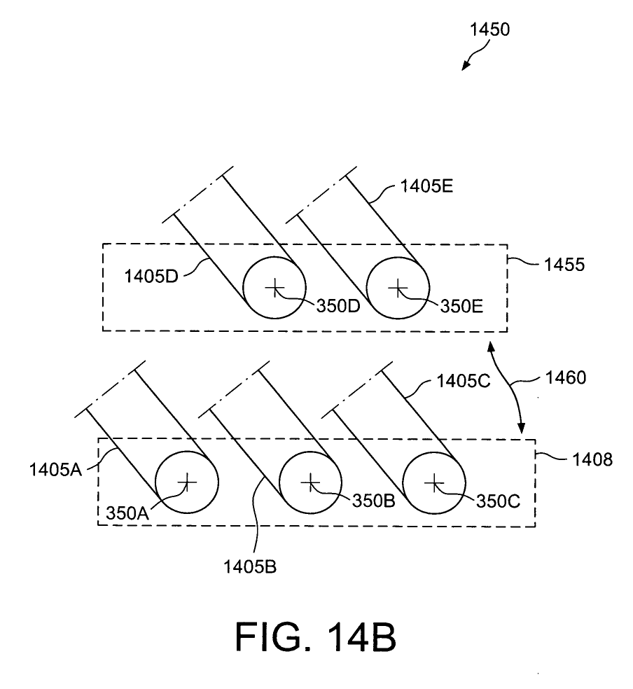

FIG. 14A is a diagram of an approximation of a fuel plume 1400 that can be generated by an embodiment of the invention. Air 345 is entrained with the example fuel droplets 1406A-1406C. As an example, the fuel plume is received by a combustion chamber bore 1402 having the sized of, e.g., approximately 65 mm bore diameter. The fuel plume length L1 depends on the compression pressure in the combustion chamber. Typically, in a diesel engine, the peak compression pressure in a diesel engine is, for example, approximately 80 bar to approximately 100 bar. The compression pressure will cause the fuel droplets to roll up, as shown by example boundaries 1410A and 1410B in the fuel droplets 1406A and 1406C.

The plume angle 365 would be wider due to air entrainment with the fuel droplets and the compression pressure against the fuel droplets. For example, the plume angel 365 is approximately 25 degrees. More entrainment of air 345 in the fuel results in a wider plume angel 365 for a plume 1406C (and for the other plumes 1406A-1406B).

The injector offset angle 1416 is the angle of a fuel injection passage with respect to an orientation of an injector axis 1420. In FIG. 14A, the fuel injection passages 1405A-1405C are shown as examples. In this embodiment of the invention, the fuel injection passages 1405A-1405C are in the same plane 1408.

The fuel injection passage 1405A is offset by an injector offset angle 1416 of, e.g., 30 degrees from the injector axis 1420. As a result, the plume 1406A travels in a direction that is substantially along the offset axis 1418.

Similarly, the fuel injection passage 1405C is offset by an injector offset angle from the injector axis 1420. A

The fuel injection passage 1405B has an orientation that is substantially along the injector axis 1420. As a result, the plume 1406B travels in a direction that is substantially along the injector axis 1420.

Embodiments of the invention advantageously provide a broader fuel plume angle which will reduce large air pocket areas in the combustion chamber by filling these large air pocket areas with fuel droplets. In other words, an embodiment of the invention allows the improved entrainment of air into the fuel, resulting in a broad plume angle for the air-fuel mixture that is transmitted to the combustion chamber or/and non-homogenous patterns of decreased fuel droplet sizes for the air-fuel mixture.

FIG. 14B is a partial front view of an apparatus 1450 including a plurality of fuel injection passages that are not in the same plane, in accordance with an embodiment of the invention. As discussed above, in an embodiment of the invention, a plurality of fuel injection passages (e.g., passages 1405A-1405C that output the fuel flows 350A-350C, respectively) are in the same first plane 1408. In another embodiment of the invention, at least one fuel injection passage is in a second plane 1455. In the example of FIG. 14B, the fuel injection passages 1405D-1405E (that output the fuel flows 350D-350E, respectively) are in the second plane 1455. Therefore, the first group of passages 1405A-1405C is in a dispersed orientation (staggered orientation) from the second group of passages 1405D-1405E. The first plane 1408 is oriented along the injector axis 1420 (FIG. 14A) and the second plane 1455 is offset by an offset angle 1460 from the first plane 1408 (and injector axis 1420).

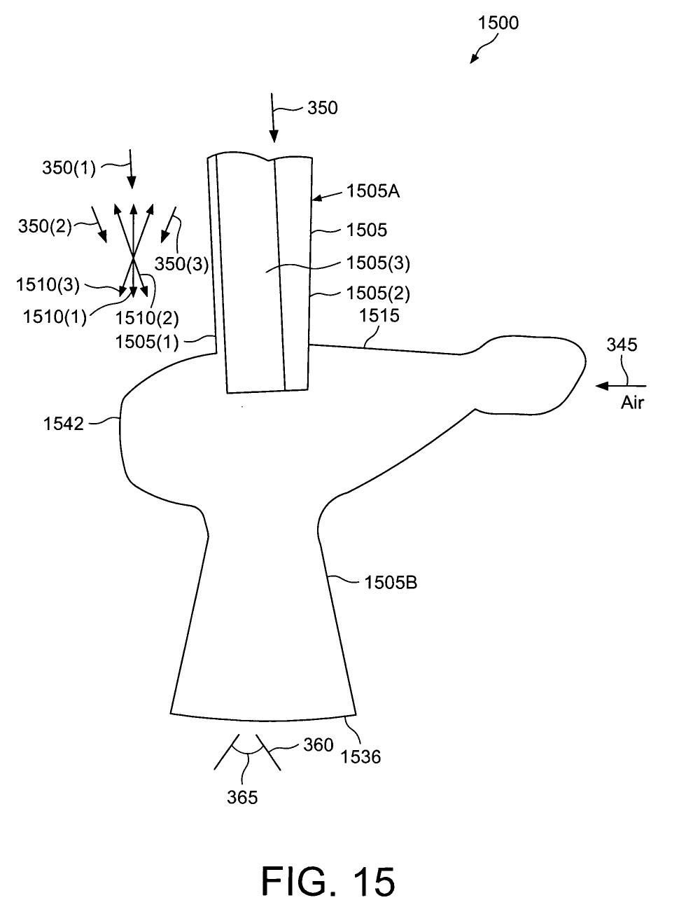

FIG. 15 is a partial cross-sectional view of an apparatus including a plurality of twisted (non-parallel) fuel inlets 1505A in the fuel injection passage 1505. The fuel injection passage 1505 also includes a conical diffusor 1505B with an outlet 1536 for releasing the fuel plume 360. A laval nozzle 1515 also forms the air passage for transmitting air 345 that will be entrained with the fuel 350. In other embodiments of the invention, the air passage 1515 is not a laval nozzle and is instead other embodiments of the air passage configurations as disclosed above.

The twisted fuel inlets 1505A is formed by, for example, the fuel paths 1505(1)-1505(3) which are separate holes that are drilled through the material that forms the fuel injection passage 1505. The fuel paths 1505(1)-1505(3) may be drilled by, for example, laser drilling or other suitable machining methods. The number of fuel paths may vary in number.

The fuel paths 1505(1), 1505(2), and 1505(3) will have axis lines (center lines) 1510(1), 1510(2), and 1510(3), respectively, as best shown in FIG. 15. The axis lines 1510(1) to 1510(3) are non-parallel (i.e., are skewed, offset, or twisted) as shown in FIG. 15. Therefore, the fuel flows 350(1), 350(2), and 350(3) through the fuel paths 1505(1), 1505(2), and 1505(3), respectively, will also be non-parallel as shown in FIG. 15 and will substantially flow in the direction of the axis lines 1510(1), 1510(2), and 1510(3), respectively.

The non-parallel fuel flows 225(1)-225(3) will introduce a swirl-like or twist-like (or other disturbance) to the fuel flow in the fuel passage 1505. Therefore, the kinetic energy of the fuel flow through fuel passage 1505 will be higher than the air flow 345 through the air passage 1515. If the fuel 350 through fuel passage 1505 has approximately 2000 bar of potential energy and approximately 700 meters/second of kinetic energy, then the impulse created by the meeting of the fuel flows 350(1)-350(3) and air 345 along the volume 1542 improves air entrainment in the fuel flow. As similarly discussed above, the air entrainment in the fuel flow permits a wider angle 365 in the fuel plume 360 that exits the outlet 1536 and aid in the bursting of fuel in the combustion chamber.

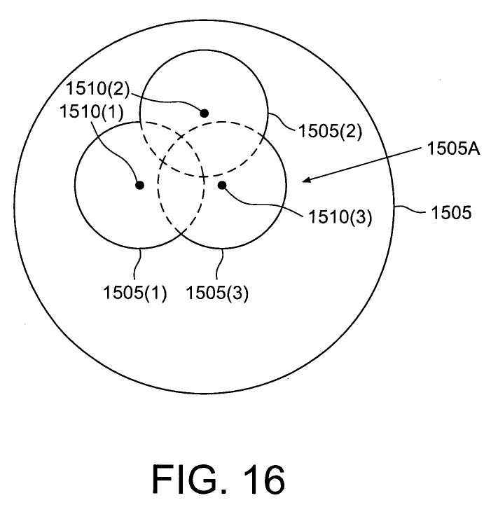

FIG. 16 is a top view of the plurality of twisted fuel paths 1505(1)-1505(3) in FIG. 15, in accordance with an embodiment of the invention. The fuel paths 1505(1)-1505(3) on the cylindrical material (e.g., pipe) that forms the fuel passage 1505 may vary in locations, configurations, and/or shape, and may vary in number. Therefore, the configuration of the fuel paths 1505(1)-1505(3) shown in FIG. 16 is not necessarily a limiting example.

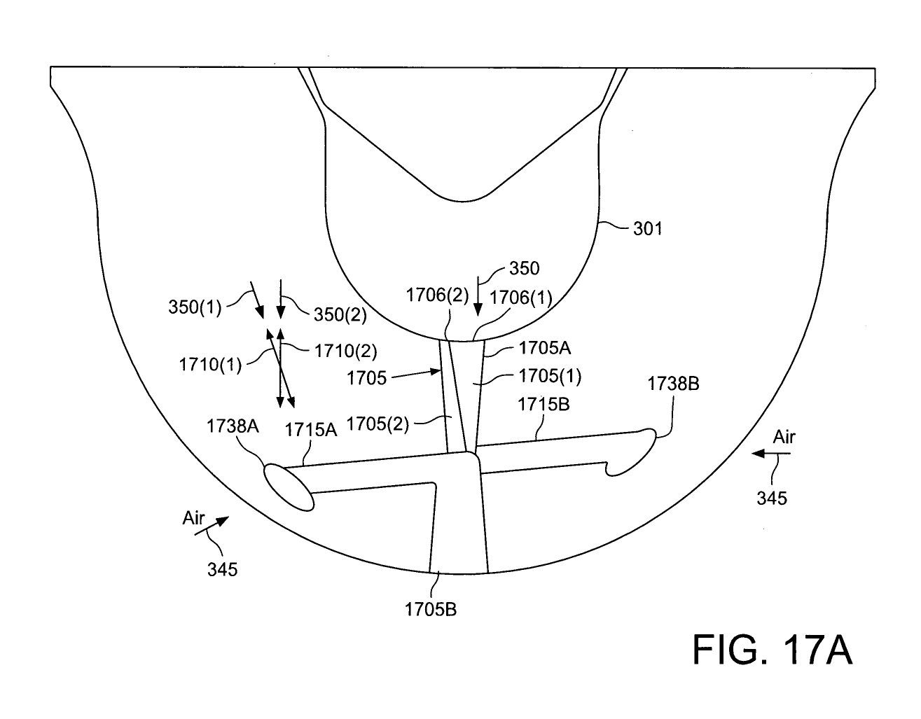

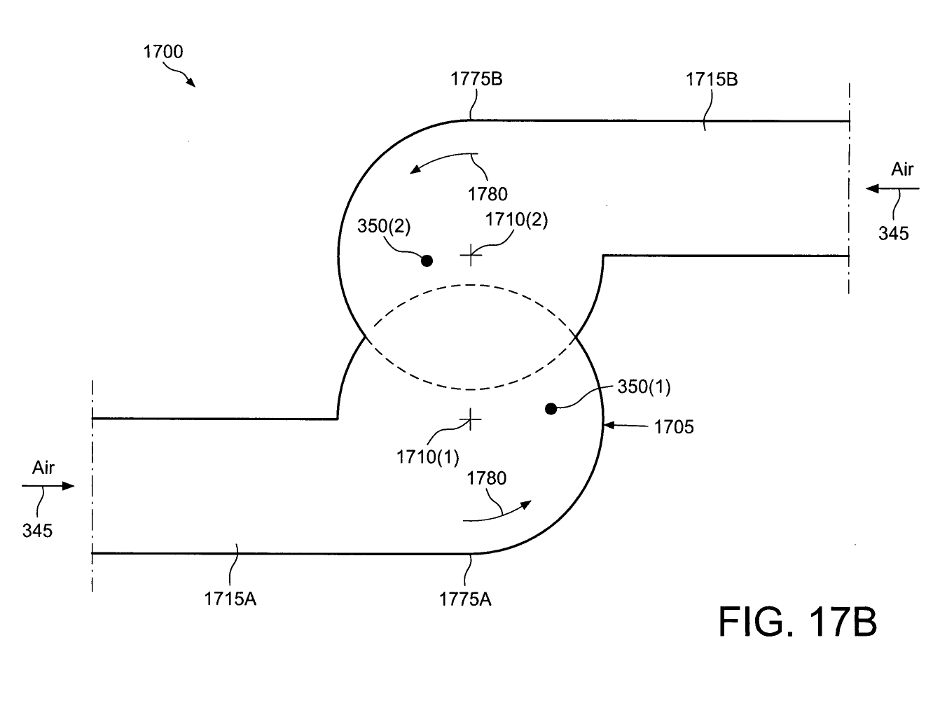

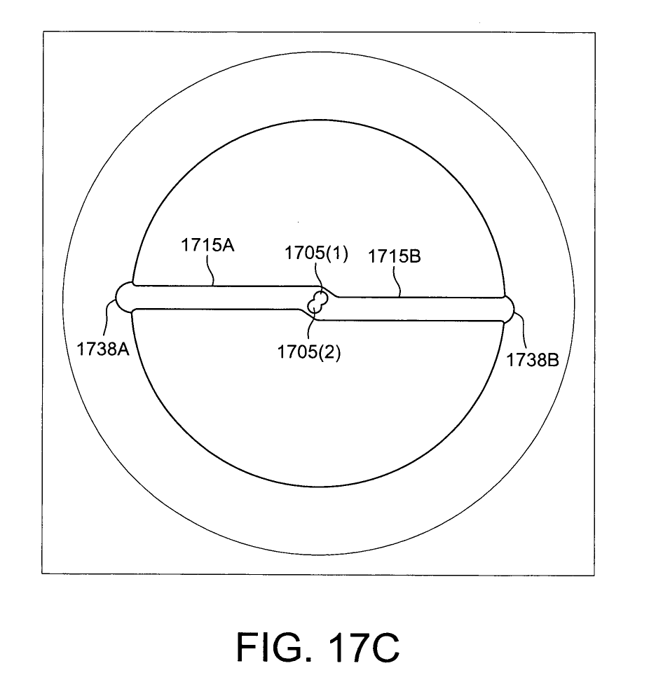

FIG. 17A is a cross-sectional view of an apparatus 1700 with a combination of various features in accordance with an embodiment of the invention. The fuel injection passage 1705 includes the twisted fuel inlets (skewed twin nozzles) 1705A and the conical diffusor 1705B. The twisted fuel inlets 1705A is formed by a plurality of non-parallel fuel paths such as, for example, the non-parallel fuel paths 1705(1)-1705(2). In an embodiment of the invention, the skewed twin nozzles are conical (k-Factor) and rounded at the entrance. The cone angle in the initial nozzle hole is called k-factor when ordering a nozzle. The cone angle can be, for example: (1) cylindrical, (2) conical opening outwardly, or (3) conical converging towards the mixing chamber which is in contact with the air passages 1715A and 1715B. A skewed nozzle entry from the sac can optionally have a rounding radii (called “HE” when ordering nozzles). The nozzle 1705(1) has the entrance 1706(1) and the nozzle 1705(2) has the entrance 1706(2). As an example, a skewed nozzle will have a diameter of 0.09 mm at its narrowest point.

The fuel paths 1705(1)-1705(2) will have the axis lines (center lines) 1710(1)-1710(2), respectively, that are non-parallel (i.e., are skewed, offset, or twisted). Therefore, the non-parallel fuel flows 350(1)-350(2), along the non-parallel fuel paths 1705(1)-1705(2), respectively, introduces a swirl or twist to the fuel flow 350 in order to improve the air entrainment in the fuel flow.

The twin tangential air passages 1715A and 1715B are connected to the fuel injection passage 1705 at a tangential junction, as similarly discussed above. The air passages 1715A and 1715B have inlets 1738A and 1738B, respectively. Each of the inlets 1738A and 1738B has a shape that decreases the flow resistance for the air 345. For example, each of the inlets 1738A and 1738B has a bell-mouth shape as shown in the example of FIG. 17A. In another embodiment, each of the inlets 1738A and 1738B has another shape for reducing air low resistance such as, for example, a conical shape, bottleneck shape, or another suitable shape for reducing flow resistance. The various features that are shown in FIG. 17A for the apparatus 1700 can be manufactured by use of, for example, laser machining, EDM, or other suitable manufacturing methods.

FIG. 17B is a partial top cross-sectional view of the apparatus 1700 of FIG. 17A, in accordance with an embodiment of the invention. The air passage 1715A is substantially tangential to the fuel injection passage 1705 at the tangential junction 1775A at the front surface of fuel injection passage 1705. The air passage 1715B is substantially tangential to the fuel injection passage 1705 at the tangential junction 1775B at the rear surface of the fuel injection passage 1705.

The air passages 1715A/1715B also provide the air swirl 1780 that provides a twisting movements to the fuel flows 350(1)-350(2). Therefore, the fuel 350 and air 345 will each have a swirl 1780 that improves air entrainment in the fuel 350 and the air entrainment will aid in bursting the fuel plume that exits the conical diffusor 1705B (FIG. 17A).

FIG. 17C is another partial top cross-sectional view of the apparatus 1700 of FIG. 17A, in accordance with an embodiment of the invention. A top cross-sectional view of the skewed twin nozzles 1705(1) and 1705(2) are shown with respect to the tangential offset air passages 1715A and 1715B.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for fuel injection that permits efficient combustion, comprising:
a fuel injector including an injector needle;
a fuel injection passage having a fuel injection passage inlet connected to the injector needle and a fuel injection passage outlet; and
an air passage having an air passage outlet that is connected to the fuel injection passage and that is located between the fuel injection passage inlet and the fuel injection passage outlet;
wherein the air passage provides air that mixes with the fuel in the fuel injection passage so that the fuel will have an increased fuel plume angle as the fuel exits from the fuel injection passage outlet.

2. The apparatus of claim 1, wherein the fuel injection passage has a constant injection passage diameter.

3. The apparatus of claim 2, wherein the fuel injection passage is cylindrical.

4. The apparatus of claim 1, wherein the air passage has a constant air passage diameter.

5. The apparatus of claim 4, wherein the air passage is cylindrical.

6. The apparatus of claim 1, wherein the air passage is connected substantially perpendicular to the fuel injection passage.

7. The apparatus of claim 1, wherein the fuel injection passage inlet is a round-shaped opening.

8. The apparatus of claim 1, wherein the fuel injection passage outlet is a round-shaped opening.

9. The apparatus of claim 1, wherein the air passage comprises an air passage inlet with a round-shaped opening.

10. The apparatus of claim 1, wherein the fuel injection passage has a first diameter and the air passage has a second diameter and wherein the first diameter is larger than the second diameter.

11. The apparatus of claim 1, wherein the air passage and the fuel injection passage are non-perpendicular.

12. The apparatus of claim 1, further comprising:
a second fuel injection passage connected to the injector needle; and
a second air passage connected to the fuel injection passage.

13. The apparatus of claim 1, further comprising:
a plurality of additional fuel injection passages connected to the injector needle, wherein the additional fuel injection passages form an umbrella configuration around the injector needle; and
a plurality of additional air passages, wherein a corresponding air passage of the additional air passages is connected to a corresponding fuel injection passage of the additional fuel injection passages.

14. The apparatus of claim 1, wherein the fuel injection passage inlet is conical.

15. The apparatus of claim 1, wherein the fuel injection passage outlet is conical.

16. The apparatus of claim 1, wherein the air passage inlet is conical.

17. The apparatus of claim 1, wherein the fuel injection passage comprises a Venturi between the fuel injection passage inlet and the fuel injection passage outlet.

18. The apparatus of claim 17, wherein the air passage comprises an air passage outlet that is connected to the Venturi.

19. The apparatus of claim 1, wherein the fuel injection passage inlet is bottleneck in shape.

20. The apparatus of claim 1, wherein the fuel injection passage outlet is bottleneck in shape.

21. The apparatus of claim 1, wherein the air passage inlet comprises a bell-mouth shape.

22. The apparatus of claim 1, wherein the air passage comprises a first air passage with a first centerline and a second air passage with a second centerline, and
wherein the first centerline and the second centerline do not intersect a centerline of the fuel injection passage.

23. The apparatus of claim 22, wherein the first air passage and second air passage are connected at a tangential junction to the fuel injection passage so that the air passages provides air that provides rotation to the fuel in the fuel injection passage.

24. The apparatus of claim 22, wherein the first air passage is parallel to the second air passage.

25. The apparatus of claim 22, wherein the first air passage and the second air passage are not parallel.

26. The apparatus of claim 22, wherein the first air passage and the second air passage are tangentially offset at the fuel injection passage.

27. The apparatus of claim 22, wherein the first air passage is tangentially coupled to a front surface of the fuel injection passage and the second air passage is tangentially coupled to a rear surface of the fuel injection passage.

28. The apparatus of claim 22 wherein the fuel injection passage has an axis with a direction that is at least near a direction of an injector axis of the injector.

29. The apparatus of claim 1, wherein the fuel injection passage comprises:
a conical jet having a conical jet inlet with a maximum conical jet diameter and a conical jet outlet with a minimum conical jet diameter; and
a conical diffuser having a conical diffusor inlet with a minimum conical diffusor diameter and a conical diffusor outlet with a maximum conical diffusor diameter.

30. The apparatus of claim 1, wherein the air passage comprises a laval nozzle for allowing an increased speed flow for the air.

31. The apparatus of claim 30, further comprising at least an additional laval nozzle.

32. The apparatus of claim 1, wherein the fuel injection passage comprises a plurality of twisted fuel inlets.

33. The apparatus of claim 32, wherein the air passage comprises a first air passage and a second air passage, wherein the first air passage and the second air passage are connected at a tangential junction to the fuel injection passage so that the air passages provides air that provides rotation to the fuel in the fuel injection passage.

34. The apparatus of claim 1, wherein the fuel injection passage comprises a first fuel path with a first fuel path axis and a second fuel path with a second fuel path axis, wherein the first fuel path axis and the second fuel path axis are non-parallel.

35. The apparatus of claim 34, wherein the fuel passage comprises a third fuel path with a third fuel path axis, wherein the first fuel path axis, the second fuel path axis, and the third fuel path axis are non-parallel.

36. The apparatus of claim 34, wherein the first fuel path provides a first fuel flow and the second fuel path provides a second fuel flow so that the first fuel flow and second fuel flow are non-parallel.

37. The apparatus of claim 36, wherein the third fuel path provides a third fuel flow so that the first fuel flow, second fuel flow, and third fuel flow are non-parallel.

38. The apparatus of claim 1, wherein a first fuel injection passage has an orientation that is substantially along an injector axis.

39. The apparatus of claim 1, wherein a second fuel injection passage has an orientation that is offset from an injector axis.

40. The apparatus of claim 1, wherein each fuel injection passage is in a first plane.

41. The apparatus of claim 1, wherein a first fuel injection passage is in a first plane and a second fuel injection passage is in a second plane.

42. A method for fuel injection that permits efficient combustion, the method comprising:
flowing fuel along a fuel injection passage, the fuel flowing from a fuel injection passage inlet of the fuel injection passage to a fuel injection passage outlet of the fuel injection passage; and
flowing air along an air passage having an air passage outlet that is connected to the fuel injection passage and that is located between the fuel injection passage inlet and the fuel injection passage outlet;
mixing the air with the fuel in the fuel injection passage so that the fuel will have an increased fuel plume angle as the fuel exits from the fuel injection passage outlet.

43. The method of claim 42, further comprising:
injecting the fuel from a plurality of fuel injection passages that form an umbrella configuration around the injector needle.

44. The method of claim 42, wherein the air passage comprises a first air passage and second air passage are connected at a tangential junction to the fuel injection passage; and
providing air along the air passages so that the air provides rotation to the fuel in the fuel injection passage.

45. The method of claim 42, further comprising:
injecting the fuel from the fuel injection passage that has an axis with a direction that is at least near a direction of an injector axis of the injector.

46. The method of claim 42, further comprising:
flowing the fuel along a conical jet inlet and a conical diffuser of the fuel injection passage.

47. The method of claim 42, further comprising:
flowing the air along a laval nozzle for allowing an increased speed flow for the air.

48. The method of claim 42, further comprising:
flowing the fuel a plurality of twisted fuel inlets of the fuel injection passage.

49. The method of claim 48, wherein the air passage comprises a first air passage and second air passage are connected at a tangential junction to the fuel injection passage; and
providing air along the air passages so that the air provides rotation to the fuel in the fuel injection passage.

50. The method of claim 42, further comprising:
providing a first fuel flow and a second fuel flow so that the first fuel flow and second fuel flow are non-parallel.

51. The method of claim 42, further comprising:
injecting a first fuel flow from a fuel injection passage in a first plane.

52. The method of claim 51, further comprising:
injecting a second fuel flow from a second fuel injection passage in a second plane.

53. An apparatus for fuel injection that permits efficient combustion, the apparatus comprising:
means for flowing fuel along a fuel injection passage, the fuel flowing from a fuel injection passage inlet of the fuel injection passage to a fuel injection passage outlet of the fuel injection passage; and
means for flowing air along an air passage having an air passage outlet that is connected to the fuel injection passage and that is located between the fuel injection passage inlet and the fuel injection passage outlet;
means for mixing the air with the fuel in the fuel injection passage so that the fuel will have an increased fuel plume angle as the fuel exits from the fuel injection passage outlet.

54. The apparatus of claim 53, further comprising:
means for injecting the fuel from a plurality of fuel injection passages that form an umbrella configuration around the injector needle.

55. The apparatus of claim 53, wherein the air passage comprises a first air passage and second air passage are connected at a tangential junction to the fuel injection passage; and
means for providing air along the air passages so that the air provides rotation to the fuel in the fuel injection passage.

56. The apparatus of claim 53, further comprising:
means for injecting the fuel from the fuel injection passage that has an axis with a direction that is at least near a direction of an injector axis of the injector.

57. The apparatus of claim 53, further comprising:
means for flowing the fuel along a conical jet inlet and a conical diffuser of the fuel injection passage.

58. The apparatus of claim 53, further comprising:
means for flowing the air along a laval nozzle for allowing an increased speed flow for the air.

59. The apparatus of claim 53, further comprising:
means for flowing the fuel a plurality of twisted fuel inlets of the fuel injection passage.

60. The apparatus of claim 59, wherein the air passage comprises a first air passage and second air passage are connected at a tangential junction to the fuel injection passage; and
means for providing air along the air passages so that the air provides rotation to the fuel in the fuel injection passage.

61. The apparatus of claim 53, further comprising:
means for providing a first fuel flow and a second fuel flow so that the first fuel flow and second fuel flow are non-parallel.

62. The apparatus of claim 53, further comprising:
means for injecting a first fuel flow from a fuel injection passage in a first plane.

63. The apparatus of claim 62, further comprising:
means for injecting a second fuel flow from a second fuel injection passage in a second plane.
